(19) United States
(12) Patent Application Publication
(10) Pub. No.: US 2026/0082278 A1
(43) Pub. Date: Mar. 19, 2026

(54) ON-DEVICE HYBRID MACHINE LEARNING MODEL FOR CALL OPTIMIZATION

(71) Applicant: Samsung Electronics Co., Ltd., Suwon-si (KR)

(72) Inventors: Sachin Kumar GUPTA, Greater Noida West (IN); Himanshu SHARMA, Ghaziabad (IN)

(21) Appl. No.: 18/962,565

(22) Filed: Nov. 27, 2024

Related U.S. Application Data
(63) Continuation of application No. PCT/KR2024/016429, filed on Oct. 25, 2024.

(30) Foreign Application Priority Data
Sep. 16, 2024 (IN) 202411069940

(51) Int. Cl. H04W 28/18; H04L 65/1016; H04L 65/80

(52) U.S. Cl. CPC H04W 28/18; H04L 65/80; H04L 65/1016

(57) ABSTRACT

Embodiments of the present disclosure disclose method and apparatus optimizing call quality in a user equipment (UE). The method includes: identifying a mobile originated (MO) call or a mobile terminated (MT) call satisfying one or more criteria; capturing a plurality of parameters associated with the MO call or the MT call and the UE, based on the MO call or the MT call satisfying the one or more criteria and correlating the plurality of parameters with historical call data to identify one or more patterns influencing the call quality; analyzing, using a hybrid machine learning (ML) model, the one or more identified patterns and predicting call quality issues for the MO call or the MT call; and adjusting UE resources based on the predicted call quality issues and real time context data and adjusting includes providing recommendations for a user of the UE.

### CROSS-REFERENCE TO RELATED APPLICATIONS

This application is a continuation of International Application No. PCT/KR2024/016429 designating the United States, filed on Oct. 25, 2024, in the Korean Intellectual Property Receiving Office and claiming priority to Indian Patent Application number 101411069940, filed on Sep. 16, 2024, in the Indian Patent Office, the disclosures of each of which are incorporated by reference herein in their entireties.

### BACKGROUND

### Field

The present disclosure relates to wireless communication. For example, the present disclosure relates to method and apparatus for optimizing call quality in a user equipment (UE).

### Description of Related Art

Presently, calls carried over IP networks are affected by technical impairments, influencing the users' subjective perception of the call. Usual technical issues include coding distortion, packet loss, poor network connection, bandwidth limitations, packet delay, and its variations (jitter). These impairments and the final quality experienced by the user become quite annoying.

Initial call is setup with best available radio access technology (RAT) and best coding technique ensuring good connectivity and best call quality. There is impact on quality and health especially in long duration calls. It is observed that most of long duration calls are usually done with known numbers and/or from known locations frequently.

Unpredictable call quality degradation for known User Equipment (UE) during calls, even for a user with consistent call patterns and locations. Such calls are usually done with known numbers and from known locations, thus call quality irritates the user. Long duration calls are of utmost importance for the user, and a user generally wants to continue over such calls without any disturbance.

Conventional solutions are holistic in nature and try to address the issue of call quality as over for all, that is why such solutions are not practical and inefficient to address the issue that may exist in practical. Since, they do not consider a known UE and it's both side performance during a call type between two or more known users.

Currently, there are few network-based solutions that monitor the network performance and manage a plurality of UE and their resource allocation. However, these network-based solutions are not programmed to track every state of UE. Further, user call preference for a known user in known location/spot and known user issues such as speaking loud or slow or long duration or whisper affecting call behavior and UE performance are not considered yet.

Also, these solutions do not consider real-time user activity (movement) or background noise levels that can affect call quality. The user is required to perform network optimization for call quality improvement (e.g. user changes location for better signal strength or manually change RAT.

In view of the foregoing, there exists a need in the art to provide a method and an apparatus which addresses the stated problems by optimizing/improving call quality in a user equipment.

The information disclosed in this background of the disclosure section is only for enhancement of understanding of the general background of the disclosure and may not be taken as an acknowledgement or any form of suggestion that this information forms the prior art already known to a person skilled in the art.

### SUMMARY

In an example embodiment, a method for optimizing call quality in a user equipment (UE) is disclosed. The method includes: identifying that a mobile originated (MO) call or a mobile terminated (MT) call satisfies one or more criteria comprising a call from frequent location, a call to frequent location, a call type, a call from known entity, and a call to known entity and capturing a plurality of parameters associated with the MO call or the MT call and the UE, based on the MO call or the MT call satisfying the one or more criteria; correlating the plurality of parameters with historical call data to identify one or more patterns influencing the call quality and analyzing, using a hybrid machine learning (ML) model, the one or more identified patterns and predicting call quality issues for the MO call or the MT call; and adjusting UE resources based on the predicted call quality issues and real time context data.

In an example embodiment, an apparatus for optimizing and/or improving call quality in a user equipment (UE) is disclosed. The apparatus includes: a memory configured to store instructions; at least one processor, comprising processing circuitry, individually and/or collectively, configured to execute the instructions stored in the memory and to: identify a mobile originated (MO) call or a mobile terminated (MT) call that satisfies one or more criteria comprising at least one of a call from frequent location, a call to frequent location, a call type, and a call from known entity, and a call to known entity, and capture a plurality of parameters associated with the MO call or the MT call and the UE, if the MO call or the MT call satisfies the one or more criteria; correlate the plurality of parameters with historical call data to identify one or more patterns influencing the call quality and analyze, using a hybrid machine learning (ML) model, the correlations identified and predict call quality issues for the MO call or the MT call; and adjust UE resources based on the predicted call quality issues and real time context data.

### BRIEF DESCRIPTION OF THE DRAWINGS

The accompanying drawings illustrate various example embodiments and, together with the description, serve to explain the disclosed principles. The same reference numbers are used throughout the figures to reference like features and components. Various embodiments of at least one of device and methods in accordance with embodiments of the present subject matter are now described, by way of example only, and with reference to the accompanying figures. The above and other aspects, features and advantages of certain embodiments of the present disclosure will be more apparent from the following detailed description, taken in conjunction with the accompanying drawings, in which:

FIG. 1 is a diagram illustrating an environment for optimizing call quality in a user equipment (UE), according to various embodiments;

FIG. 2A illustrates a block diagram illustrating an example architecture for optimizing call quality in UE, according to various embodiments;

FIG. 2B is a diagram illustrating example functions of call analyzer in a framework for call optimization, according to various embodiments;

FIG. 2C is a diagram illustrating example functions of history dump in a framework for call optimization, according to various embodiments;

FIG. 2D is a diagram illustrating an example light weight decision tree for the ML model, according to various embodiments;

FIG. 2E is a diagram illustrating example functions of recommendation generator in a framework for call optimization, according to various embodiments;

FIG. 3 is a signal flow diagram illustrating operations two UEs with call optimization framework, according to various embodiments;

FIG. 4 is a block diagram illustrating an example configuration of an apparatus for optimizing/improving call quality in UE, according to various embodiments; and

FIG. 5 is a flowchart illustrating an example method for optimizing/improving call quality in UE, according to various embodiments.

It may be appreciated by those skilled in the art that the block diagrams herein represent conceptual views of illustrative systems embodying various principles of the present subject matter. Similarly, it will be appreciated that any flowcharts, flow diagrams, state transition diagrams, pseudo code, and the like represent various processes which may be substantially represented in computer-readable medium and executed by a computer or processor, whether or not such computer or processor is explicitly shown.

### DETAILED DESCRIPTION

In the disclosure, the word “exemplary” is used herein to refer, for example, to “serving as an example, instance, or illustration”. Any embodiment or implementation of the present subject matter described herein as “exemplary” is not necessarily to be construed as preferred or advantageous over other embodiments.

While the disclosure is susceptible to various modifications and alternative forms, various example embodiments been shown by way of example in the drawings and will be described in greater detail below. It can be understood, however that it is not intended to limit the disclosure to the particular forms disclosed, but on the contrary, the disclosure is to cover a plurality of modifications, equivalents, and alternative falling within the spirit and the scope of the disclosure.

The terms “comprises”, “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

In the following detailed description, reference is made to the accompanying drawings that form a part hereof, and in which are shown by way of illustration various example embodiments in which the disclosure may be practiced. The following description is, therefore, not to be taken in a limiting sense.

The terminology “Artificial intelligence (AI) model” “machine learning model” “ML Model”, and “hybrid ML model” are interchangeably used throughout the disclosure. The AI model and/or neural network may be implemented using an AI module. The AI module may be a combination of hardware module and software module. The hardware module may comprise necessary circuitry to perform the functionality discussed in below embodiments.

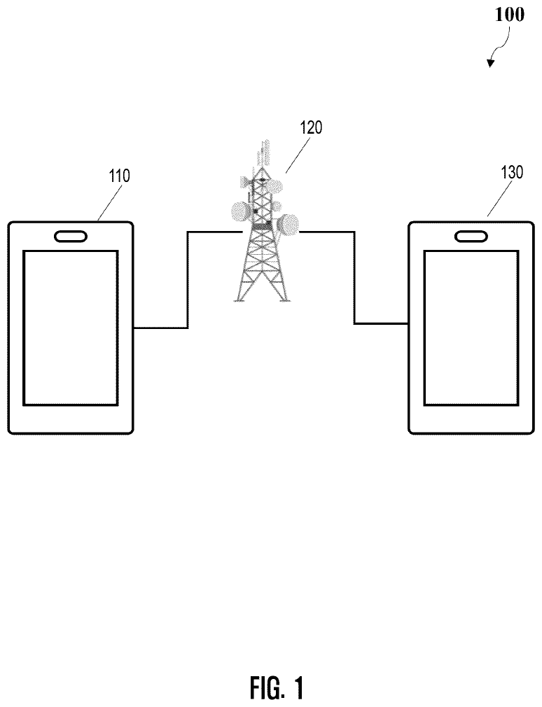

FIG. 1 is a diagram illustrating an environment for optimizing/improving call quality in a user equipment (UE), according to various embodiments.

The environment 100 comprises a UE 110 and UE 130 in communication with each other through a network element 120. In a non-limiting example, the network element 120 may comprise a base station and configured to provide wireless connectivity between the UE 110 and UE 130, and the network element 120 may be of cellular network, Personal Area Network (PAN), Local Area Network (LAN), Metropolitan Area Network (MAN), Wide Area Network (WAN). In a non-limiting example, the network may include, but not be limited to, 3G network, 4G network, 5G network, etc.

In an aspect of the present disclosure, the UE 110 may be a mobile originator device, and the UE 130 may be mobile terminator device. The UE 110 may monitor an ongoing call and check whether the other entity e.g., UE 130 is a known entity through phone book or call logs and/or the UE 130 is at known location. If the call is with the known entity present at a specific location of office/home, the UE 110 may check the history availability for the current call and may capture call type information and UE parameters to identify issues specific to a user's need. The UE parameters may comprise UE call type information: e.g. audio, video, Received Signal Strength Indicator (RSSI) variation for call type for handoff, etc.

The UE 110 may comprise a hybrid machine learning (ML) model that analyses historical call data patterns for a known user that helps to know behavior during the call. The UE 110 may be configured to provide personalized prediction that is used for UE IP Multimedia Subsystem (IMS) stack potential adjustments (e.g. adjusts resource allocation for voice and data streams, optimizing network configuration, application bandwidth prioritization based on the feedback). The UE 110 may be then configured to perform potential adjustments to improve the ongoing call and transmit the adjustments to the UE 130. For example, the UE 110 may have experienced call/voice quality/drop issues and pre-allocate more resource for call originating from that location.

In another aspect of the present disclosure, the UE 110 may determine a long duration ongoing call with a known contact. The UE 110 may determine from device sensor that device is heated up, and/or battery is low, and/or device mobility. The UE 110 may determine from the historical data that low RSSI is leading to high power consumption and is leading to high battery drainage. The hybrid ML model may be configured to provide recommendation to the user over user interface such as move to better signal location, downgrade to audio call, or close the call if possible and if none of the above-mentioned recommendation is opted, it may have adverse impact in user health and device life.

However, the above-mentioned recommendations and adjustments are illustrative and other types of recommendations and adjustments for such scenario is well within the scope of present disclosure.

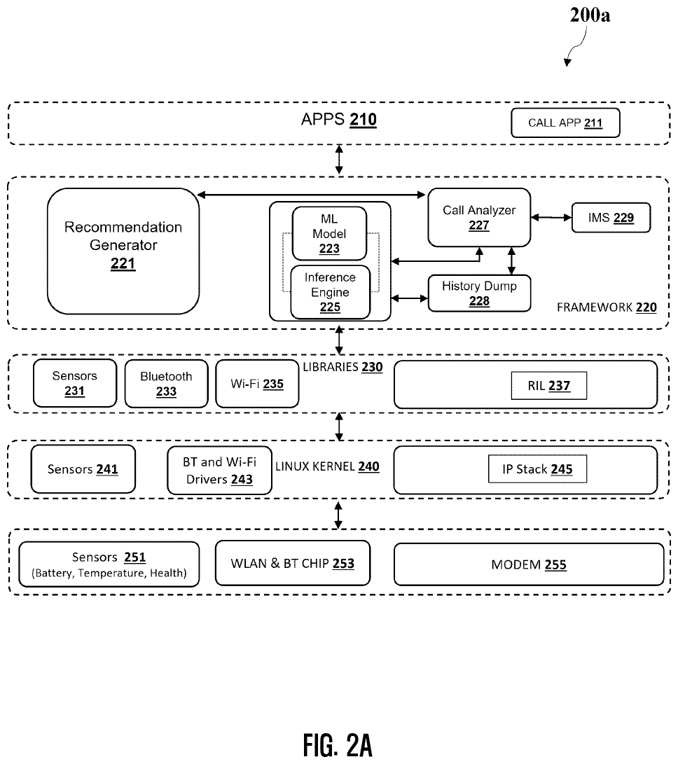

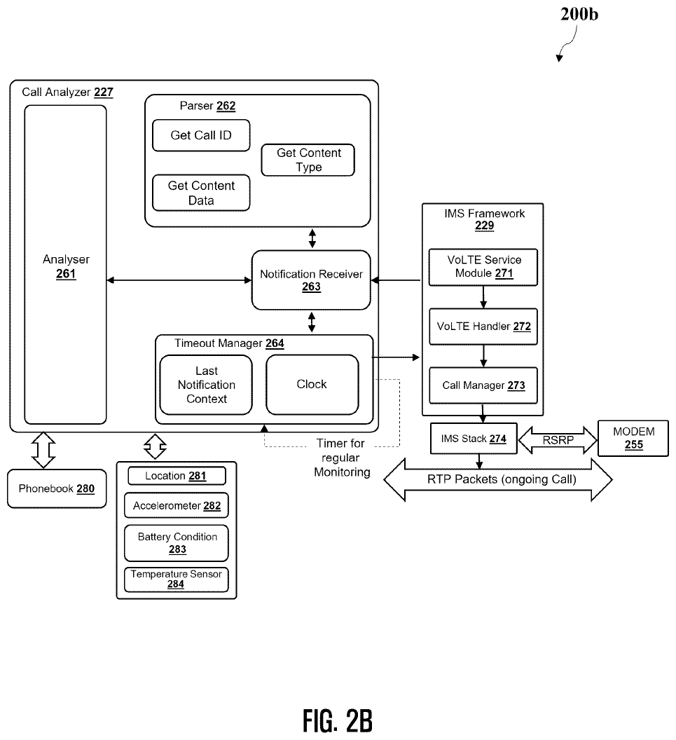

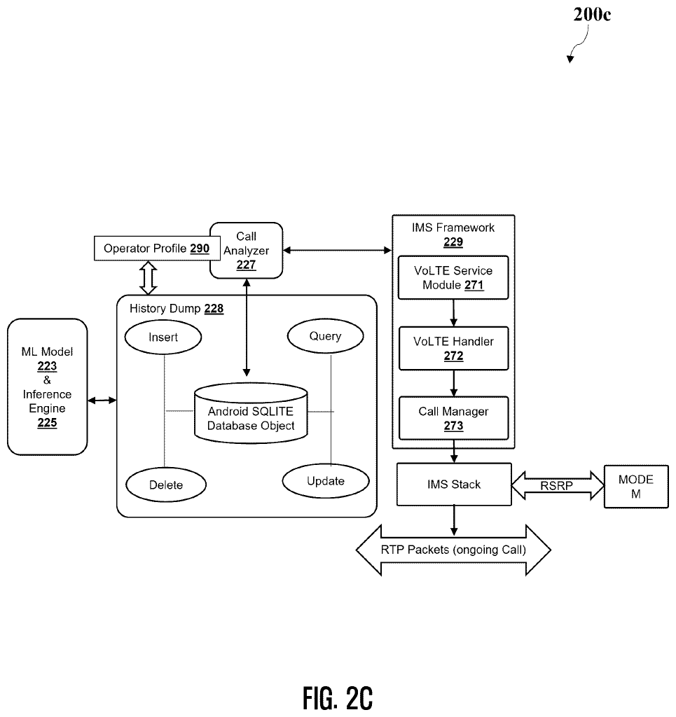

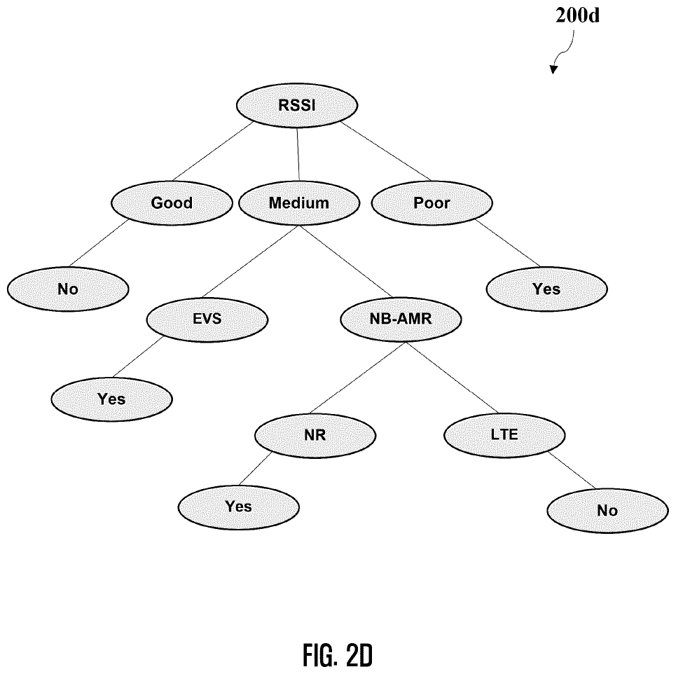

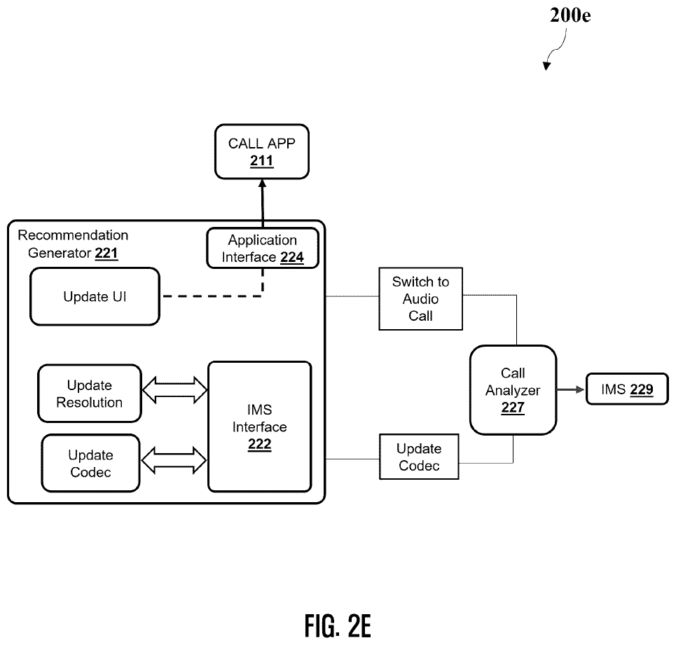

FIG. 2A is a block diagram illustrating an example architecture 200a for optimizing call quality in UE, in accordance with an embodiment of the present disclosure. In an aspect, the UE may comprise smartphones, smartwatches, tablets, laptop computers, handheld gaming consoles, etc. However, the UE is not limited to above example and may include any other equipment with calling capability.

The architecture 200 may comprise application layer 210 comprising a plurality of applications. The application layer 210 comprises a call application 211 that may be used for handling all call related operations of user interface and provides UI to the user for dialing call, receive incoming call, accept any notification, etc. In a non-limiting example, the call application 211 may be modified to provide recommendation to the user of the mobile device.

The architecture 200 may comprise framework 220 that includes recommendation generator 221, ML model 223, inference engine 225, call analyzer 227, history dump 228, and IP Multimedia Subsystem (IMS) 229. In a non-limiting example, the framework 220 may be part of the IMS framework 229.

The call analyzer 227 may be configured for periodic monitoring of ongoing call with a known user to capture information such as location, audio, video, RSSI variation for call type for handoff, mobility type and battery condition, etc.

The history dump 228 may be used for storing current call parameters for future reference, call status with location, audio, video, RSSI variation for call type for handoff, mobility type, and device parameters such as battery condition. However, the call and device parameters are not limited to above example.

The IMS 229 may be configured for handling all incoming and outgoing IMS Calls e.g. VoLTE/VoWIFI/VILTE and 5G calls. The IMS 229 may also update the current session using re-INVITE look which is similar to any other INVITE with most of the same headers and a similar message body. The IMS 229 may apply to an existing INVITE after a final response has been received and an ACK is then sent. A re-INVITE will have the same Call-ID and from tag as the INVITE.

The ML model 223 and inference engine 225 may be configured to generate personalized prediction that is used for UE IMS stack potential adjustments. For example, the UE may adjust resource allocation for voice and data streams, optimizing network configuration, application bandwidth prioritization based on the feedback.

The recommendation generator 221 may be used for adjusting device resources based on the predicted call quality issues and recommending actions such as suggest user as move to a strong signal or change area, reducing screen resolution during video call, and switch between audio or video call/switch codec.

The architecture 200 further comprises libraries 230 including sensor library 231, Bluetooth library 233, Wi-Fi library 235. The libraries 230 may also include radio interface layer (RIL) 237 between application processor and communication processor (e.g. modem 255) and is used for all communications between application processor and communication processor e.g., outgoing and incoming notification message and call on LTE/5G.

The architecture 200 further comprises LINUX kernels 240 including kernels/drivers 241 for sensors, Bluetooth & Wi-Fi routers 243, and IP stack 245. The architecture 200 further comprises hardware layer including the sensors 251, WLAN and Bluetooth chip 253 and modem 255. The sensors 251 may include battery monitoring unit, temperature sensor, and device health monitoring unit.

However, the architecture 200 is not limited to the above-mentioned software and hardware components and may comprise other components required for functioning of the user equipment.

FIG. 2B illustrates functions 200b of call analyzer 227 in a framework for call optimization, according to various embodiments.

The call analyzer 227 may comprise a parser 262 that is responsible for parsing the SIP messages received from IMS framework 229 to fetch important information like call type e.g., audio, video, SDP codecs etc., and convert these information into usable format.

The call analyzer 227 may further comprise a notification receiver 263 and timeout manager 264. The timeout manager 264 monitors SIP signaling parameters and IMS media parameters at regular intervals. Further, call type audio, video, and RSRP variation for call type for handoff is also passed to notification receiver 263.

The call analyzer 227 may be coupled to phonebook 280 is used to fetch or retrieve details of calling entity, location manager 281, accelerometer 282, and battery condition unit 283 that monitors the status or condition of the battery and temperature sensor 284. The location manager 281 may be a GPS sensor for getting last known location (LocationManager.NETWORK_PROVIDER) and the temperature 284 may get temperature of the device and may also get ambient temperature (Sensor.TYPE_AMBIENT_TEMPERATURE).

The battery condition unit 283 may comprise Battery Intent Filter (Intent.ACTION_BATTERY_CHANGED) for monitoring changing battery condition. Accelerometer 282 may be configured to detect mobility of the speed of the user equipment. For example, if the speed is <=5 km/hr, the user is walking or else user is in a motor vehicle.

The IMS framework 229 may be configured to expose application program interfaces APIs to telephony framework which are used to divert Volte, VoNR calls and SMS over IP. The IMS framework 229 may comprise multiple modules that manages the Volte/VoNR services. The IMS framework 229 may comprise VoLTE service module 271 that is configured to redirect the state to VoLTE handler 272. The VoLTE handler 272 may be configured to main class for handling IMS Call. The VoLTE handler 272 may designed to receive and handle all incoming synchronous events from the lower layers of IMS stack. The IMS framework 229 may also comprise call manager 273 that handles the state machine of the ongoing call e.g. initiated, dialling, ringing, disconnecting, disconnected, etc.

The IMS stack 274 may be configured to fetch Reference Signal Received Power (RSRP) and Reference Signal Received Quality (RSRQ) variations from the modem 255 and may be used as one of the parameters by analyzer 261.

Thus, the call analyzer 227 may be configured to identify a mobile originated (MO) call or a mobile terminated (MT) call satisfies one or more criteria. The one or more criteria includes a call from frequent location, a call to frequent location, a call type, a call from known entity, and a call to known entity. The call analyzer 227 may also be configured to capture a plurality of parameters associated with the MO call or the MT call and the UE, if the MO call or the MT call satisfies the one or more criteria. The plurality of parameters associated with the MO call or the MT call comprise at least one of audio codec, video codec, bit-rate, variation in Received Signal Strength Indicator (RSSI) values, and Evolved Packet System fallback condition, and the plurality of parameters associated with the UE comprise at least one of location, ambient temperature, mobility type, and battery level.

FIG. 2C is a diagram 200c illustrating example functions of history dump 228 in a framework for call optimization, according to various embodiments.

The history dump 228 may be configured to store operator profile 290 and may be coupled to ML model 223 and inference engine 225 for predicting issue with ongoing call. For example, the operator profile 290 may comprise:
“name”: “ECONET TELECOM LESOTHO VoLTE”,
“mnoname”: “Econet_LS”,
“representative_plmn”: “65102”,
“pdn”: “ims”,
“support_ipsec”: true,
“audio_codec”: “EVS,AMRBE-WB,AMR-WB,AMRBE,AMR,DTMFWB,DTMF”,
“enable_evs_codec”: true,
“video_codec”: “H264,H265,H263”,
“display_format”: “vga-port,720p-port”,
“evs_bit_rate_send”: “5.9-24.4”,
“evs_bit_rate_receive”: “5.9-24.4”.

The history dump module 228 may be used to store current call parameters for future reference. The call parameters call status with location, audio, video, RSSI variation for call type for handoff, mobility type, and battery condition. The call analyzer creates and stores the object of SQLITE database. The Query API of SQLITE is used to fetch a record corresponding to key (phone number of other entity). Insert API may be used to Insert the record to database. Delete API is used to delete database record. Update API may be used to update a file corresponding to key.

In a non-limiting example, the ML Model 223 may be based on light weight decision tree that classifies the output as call quality issues will be present-Yes or No call quality issues-No. An example classification of the ML Model 223 is illustrated in table 1 below.

TABLE 1

| | | | | | | Call Quality |
|---|---|---|---|---|---|---|
| | | | | | | Issues |
| TYP | RSSI | RAT | CODEC | LAT | LONG | (Yes/No) |
| Video | 130 | NR | NB-AMR | 23.76 | 90.38 | Yes |
| Audio | 85 | LTE | WB-AMR | 91.4 | 130.8 | Yes |
| Video | 65 | NR | EVS | 33.76 | 23.8 | No |
| Video | 78 | NR | EVS | 23.76 | 90.38 | No |
| Video | 110 | NR | EVS | 43.5 | 93.38 | Yes |

In a non-limiting example, the RSSI gain may be categorized as good, medium or poor. The video may have TYP 01, audio may have TYP 00, NB-AMR may be 00, WB-AMR may be 01, EVS may be 10, and AMR be 11. Then table 1 values get transformed to table 2 as shown below.

TABLE 2

| | | | | | | Call Quality |
|---|---|---|---|---|---|---|
| | | | | | | Issues |
| TYP | RSSI | RAT | CODEC | LAT | LONG | (Yes/No) |
| 00 | Poor | 11 | 00 | 23.76 | 90.38 | Yes |
| 00 | Medium | 10 | 01 | 91.4 | 130.8 | Yes |
| 01 | Medium | 11 | 10 | 33.76 | 23.8 | No |
| 01 | Medium | 11 | 10 | 23.76 | 90.38 | No |
| 01 | Poor | 11 | 10 | 43.5 | 93.38 | Yes |

In a non-limiting example, the attribute with the Maximum Information Gain is used as the root node of the tree. For example:

$$\begin{matrix}Gain ( RSSI ) = - \text{.4} {log}_{2} \text{.4} - \text{.6} {log}_{2} \text{.6} = \text{.298} \\ Gain ( RAT ) = \text{.3} \\ Gain ( CODEC ) = \text{.0} \text{.289} \\ Gain ( LAT \vert LONG ) = \text{.0478}\end{matrix}$$

As RSSI has highest gain, hence it will become Root node of decision Tree.

FIG. 2D is a diagram illustrating a light weight decision tree 200d for the ML model 223, according to various embodiments.

As shown in FIG. 2D, if RSSI is Good then no Call Quality issue is predicted. If RSSI is Poor then Call Quality issue is predicted. If RSSI is Medium and negotiated Codec is NB-AMR, then for NR RAT Call Quality issue is predicted, whereas for LTE RAT there is no Call Quality issue. If Call Quality issue is predicted, then recommendation generator 221 uses IMS 229 to send RE-INVITE in ongoing session to avoid predicted call issue.

In an example, the resource adjustment may include adjusting resource allocation for voice and data streams, optimizing network configuration, and application bandwidth prioritization. Further, suggestions may be provided to the user to move to a strong signal or change area, reducing screen resolution during video call, switch between audio or video call/switch codec.

FIG. 2E is a diagram illustrating example functions 200e of recommendation generator 221 in a framework for call optimization, according to various embodiments.

In an aspect of the present disclosure, the recommendation generator 221 is configured for adjusting device resources based on the predicted call quality issues and recommending actions e.g., suggest user as move to a strong signal or change area, reducing screen resolution during video call, and switch between audio or video call.

The recommendation generator 221 may be coupled with call application 211 via an application interface 224. The application interface 224 is updated for recommendation and corresponding action needs to be taken by the user. In an example, the suggestion may include suggesting user to move to a string signal area, notifying user to switch to audio call, notifying device is heated up, reduce call duration or disconnect.

In a non-limiting example, the recommendation generator 221 may apply the adjustments to the ongoing call through IMS interface 222 of the recommendation generator 221. In an example, the adjustments may include update Codec and/or switch to audio call and change of video port is used to convert the video call to audio call. The SIP RE-INVITE is used to update codec using call ID from ongoing call. The IMS interface 222 may be coupled to the IMS 229 via the call analyzer 227.

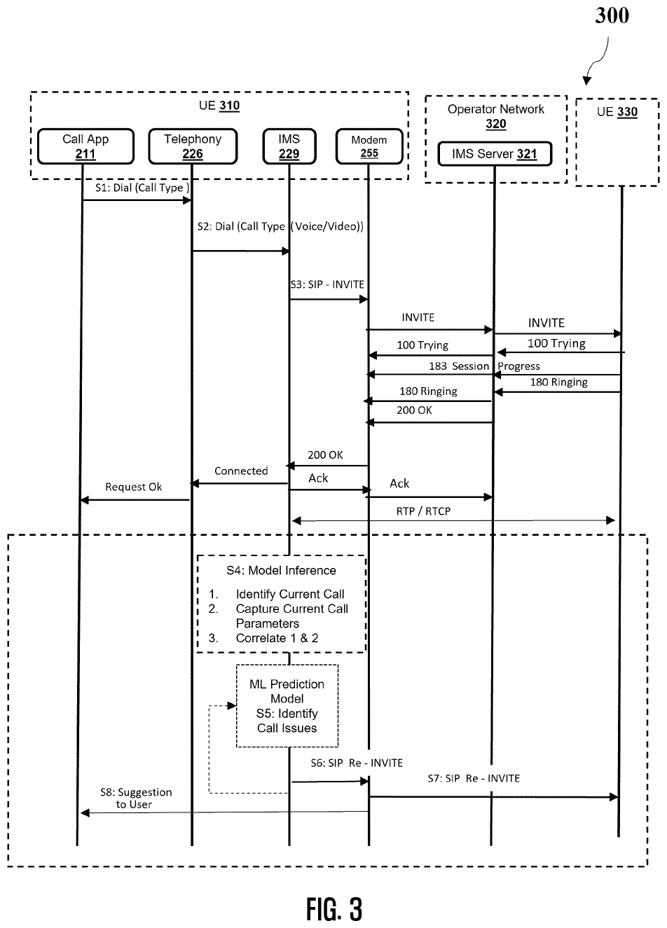

FIG. 3 is a signal flow diagram illustrating operations between two UEs with call optimization framework, according to various embodiments.

A user may dial a number using a call application 211 of the UE 310 for starting a conversation, as shown in step S1. The dialed call may have call type e.g., video or voice. In an example, voice call is indicated by call type 1 and video call is indicated by call type 2.

The dialed video/voice call is forwarded to the IMS 229 via the telephony unit 226, at step S2. The IMS 229 receives the request to setup the call from application in case of mobile originated call (MO) and setups the response in case of incoming mobile terminated (MT) call.

In case of MO call, the IMS 229 fetches operator requirement from IMS profile to fetch information such as supported codec, protocol such as RTP/RTCP handovers supported by operator such as EPSFB, VoWiFi-VOLTE, etc.

The above information is provided to the modem 255 through the SIP-INVITE signal as shown in step S3. The modem 255 may initiate SIP signaling based received SIP INVITE. The INVITE request that is sent to operator network 320 including the IMS server 321 that is responsible for initiating a session. The IMS server 321 sends a 100 Trying response immediately to the caller to stop the re-transmissions of the INVITE request. Thereafter, 180 Ringing (provisional responses) generated by MT is returned back to MO. A 200 OK response is generated soon after MT picks the phone up. MT receives an ACK from MO, once it gets 200 OK. At the same time, the session gets established and Real-time Transport Protocol (RTP)/RTP Control Protocol (RTCP) packets (conversations) start flowing from both ends. Once the successful call setup, media packet (Audio/Video) starts and information for the current call setup is saved (e.g., call type, RAT, codec, bitrate, call duration, call location, battery level, mobility, etc.

The method for call optimization is initiated at step S4. The UE 310 identifies whether the call from the UE 310 is with known entity and/or from frequent location. If the identification is found to be true, then the UE 310 captures a plurality of parameters associated with the call as well as the UE 310. Then the UE 310 correlating the plurality of parameters with historical call data to identify one or more patterns influencing the call quality.

A hybrid machine learning (ML) model of the UE 310 may be configured to analyze the one or more identified patterns and predict call quality issues for the current call as shown in step S5. In the same step, the UE 310 may adjust UE resources based on the predicted call quality issues and real time context data.

The UE resource adjustment is then communicated to the UE 330 using the SIP re-INVITE message as shown in step S6 and S7. This communication is carried out via the modem 255 of the UE 310. The re-INVITE is similar to any other INVITE with most of the same headers and a similar message body. The re-INVITE is sent with updated SDP. The re-INVITE may apply to an existing INVITE after a final response has been received and an ACK has been sent. The re-INVITE will have the same Call-ID and From tag as the INVITE. in a non-limiting example, the UE 310 may also provide one or more suggestions to the user for optimizing the call quality, as shown in step S8. For example, the suggestions may comprise user as to move to a strong signal area and/or switch from video call to audio call.

Thus, if UE 310 knows that user call to a known user from a specific location and had experienced call/voice quality/drop issues, the UE 310 may pre-allocate more resource for call originating from that location. The UE 310 can also suggest user during the call to move to a specific location or spot with the space if call quality starts to trouble the user during the conversation, thereby improving the overall call quality and improving user experience during the call.

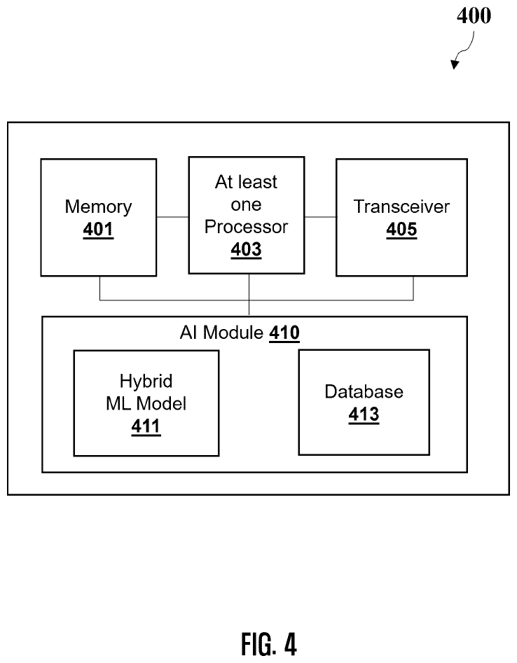

FIG. 4 is a block diagram illustrating an example configuration of an apparatus 400 for optimizing call quality in UE, according to various embodiments. In a non-limiting example, the apparatus 400 may be a UE. In a non-limiting example, the apparatus 400 may be a sub-system of the UE.

In an embodiment of the present disclosure, the apparatus 400 may comprise a memory 401, at least one processor (e.g., including processing circuitry) 403, transceiver (e.g., including circuitry) 405, and an AI module (e.g., including various circuitry and/or executable program instructions) 410 communicatively coupled with each other. The AI module 410 may further comprise an AI Model (e.g., including executable program instructions) 411 and a database 413. The AI Model 411 may be a hybrid machine learning (ML) model. In a non-limiting example, the apparatus 400 may also comprise an input/output module or interface (not shown).

At least one of the plurality of modules of apparatus 400 may be implemented through an AI model. A function associated with AI may be performed through the non-volatile memory, the volatile memory, and the processor.

The at least one processor 403 may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The at least one processor 403 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The one or a plurality of processors control the processing of the input data in accordance with a predefined operating rule or artificial intelligence (AI) model stored in the non-volatile memory and the volatile memory. The predefined operating rule or artificial intelligence model is provided through training or learning.

Being provided through learning may refer, for example, to, by applying a learning algorithm to a plurality of learning data, a predefined operating rule or AI model of a desired characteristic being made. The learning may be performed in a device itself in which AI according to an embodiment is performed, and/o may be implemented through a separate server/system.

In an aspect of the present disclosure, the AI model 411 may include a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a UE) using a plurality of learning data to cause, allow, or control the target device to make a determination or prediction. Examples of learning algorithms include, but are not limited to, supervised learning, unsupervised learning, semi-supervised learning, or reinforcement learning.

It may be noted that, in various embodiments, the apparatus 400 may include more or fewer components than those depicted herein. The various components of the apparatus 400 may be implemented using hardware, software, firmware or any combinations thereof. Further, the various components of the apparatus 400 may be operably coupled with each other. More specifically, various components of the apparatus 400 may be capable of communicating with each other using communication channel media (such as buses, interconnects, etc.).

In an embodiment, the at least one processor 403 may be embodied as a multi-core processor, a single core processor, or a combination of one or more multi-core processors and one or more single core processors. For example, the at least one processor 403 may be embodied as one or more of various processing devices, such as a coprocessor, a microprocessor, a controller, a digital signal processor (DSP), a processing circuitry with or without an accompanying DSP, or various other processing devices including, a microcontroller unit (MCU), a hardware accelerator, a special-purpose computer chip, or the like.

In an embodiment, the memory 401 is capable of storing machine executable instructions, referred to herein as instructions. In an embodiment, the at least one processor 403 are embodied as an executor of software instructions. As such, the at least one processor 403 are capable of executing the instructions stored in the memory 401 to perform one or more operations described herein.

The memory 401 can be any type of storage accessible to the at least one processor 401 to perform respective functionalities. For example, the memory 401 may include one or more volatile or non-volatile memories, or a combination thereof. For example, the memory 401 may be embodied as semiconductor memories, such as flash memory, mask ROM, PROM (programmable ROM), EPROM (erasable PROM), RAM (random access memory), etc. and the like.

In an embodiment, the AI Model 411 may be configured in the internal memory or storage of the AI module 410 for predicting call quality issues and generating recommendations or resource adjustment parameters. Some examples of the one or more AI models 411 include, but not limited to, neural network, deep neural networks, Machine Learning (ML) model, and the like. However, the AI Model 411 is not limited to this example and any other AI model that may be trained to perform the below mention functionality is well within the scope of present disclosure.

In an aspect of the present disclosure, an ongoing call is monitored for optimization. The optimization facilitated by the apparatus 400 is for improving the call quality.

In an aspect of the present disclosure, the at least one processor 403 may be configured to identify a mobile originated (MO) call or a mobile terminated (MT) call satisfies one or more criteria. The one or more criteria may comprise at least one of a call from frequent location, a call to frequent location, a call type, a call from known entity, and a call to known entity. The location may be determined from a GPS sensor of the UE and known entity may be determined from the phonebook stored in the UE.

In a non-limiting example, the criteria may also include previous history of long duration call. However, the one or more criteria is not limited to above example and any other criteria which indicates the familiarity between caller is well within the scope of the present disclosure.

The at least one processor 403 may be configured to capture a plurality of parameters associated with the MO call or the MT call and the UE, if the MO call or the MT call satisfies the one or more criteria. The plurality of parameters associated with the MO call or the MT call may comprise at least one of audio codec, video codec, bit-rate, variation in Received Signal Strength Indicator (RSSI) values, and Evolved Packet System fallback condition. And the plurality of parameters associated with the UE may comprise at least one of location, ambient temperature, mobility type, and battery level. These call parameters may be fetched from the network and UE parameters may be fetched directly from different sensor/modules of the UE, as discussed in above aspects. However, the plurality of parameters associated with the call and the plurality of parameters associated with the UE is not limited to above example, and any other parameter known to a person skilled in the art is well within the scope of present disclosure.

Once the plurality of parameters are captured, the at least one processor 403 may be configured to correlate the plurality of parameters with historical call data to identify one or more patterns influencing the call quality. The at least one processor 403 may be configured to analyze, using the AI Model 411, the correlations identified and predict call quality issues for the MO call or the MT call.

In a non-limiting example, the AI Model 411 may be trained for predicting call quality issues. For training the AI Model 411, the at least one processor 403 may be configured to receive historical call data of the UE. The historical call data comprises call parameters associated with a plurality of calls and corresponding contribution of the call parameters to influence the call quality during the plurality of calls. The at least one processor 403 may be configured to train the AI Model 411 with a plurality of patterns present in the historical call data. Each pattern may include a call parameter and corresponding contribution of the call parameter.

Further, the at least one processor 403 may also be configured to receive a plurality of call quality issues experienced by users during the call and one or more respective issue resolution recommendation and train the AI Model 411 model with the plurality of call quality issues experienced by the users during the call and the one or more respective issue resolution recommendation for real time UE resource adjustment.

After the call issues are predicted, the at least one processor 403 may also be configured to adjust UE resources based on the predicted call quality issues and real time context data. The real time context data comprises at least one of ambient noise experienced during the MO call or the MT call, call mutes experienced during the MO call or the MT call, and real time voice metrics.

For the adjustment of the UE resources, the at least one processor 403 may be configured to provide one or more of pre-allocation media protocol selection, adaptive bit-rate, network configuration optimization, application bandwidth prioritization, and recommendations for a user of the UE. However, the adjustment of UE resources is not limited to above example and any other UE resource adjustment that may improve the call quality for an identified/predicted call issue is well within the scope of present disclosure.

To provide recommendation for the user of the UE, the at least one processor 403 may be configured to provide at least one of position change recommendation, reducing screen resolution recommendation during a video call, switching audio call to video call recommendation, and switching video call to audio call recommendation. However, the recommendation for the user is not limited to above example and any other recommendation for the user/user equipment is well within the scope of present disclosure.

Thus, if UE knows that user call to a known user from a specific location and had experienced call/voice quality/drop issues, the UE may pre-allocate more resource for call originating from that location. The UE can also suggest user during the call to move to a specific location or spot with the space if call quality starts to trouble the user during the conversation, thereby improving the overall call quality and improving user experience during the call.

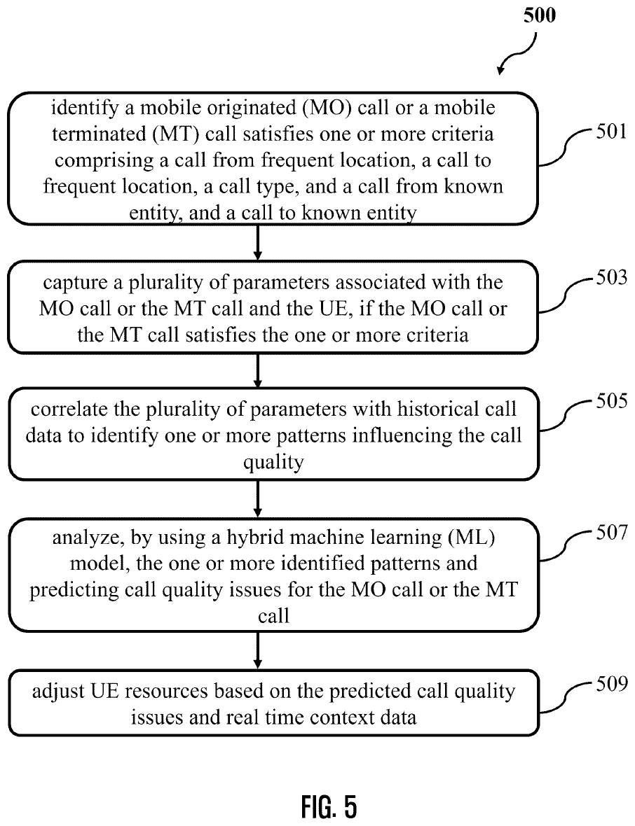

FIG. 5 is a flowchart illustrating an example method 500 for optimizing/improving call quality in a user equipment (UE), according to various embodiments. The method 500 illustrated in the flowchart may be executed by, for example, the apparatus 400. Operations of the flow diagram, and combinations of operation in the flow diagram, may be implemented by, for example, hardware, firmware, a processor, circuitry and/or a different device associated with the execution of software that includes one or more computer program instructions.

It is noted that the operations of the method 500 may be described and/or practiced using at least one processor 403 of the apparatus or device other than the apparatus 400 such as UE.

At step 501, the method 500 discloses identifying a mobile originated (MO) call or a mobile terminated (MT) call that satisfies one or more criteria. The one or more criteria may comprise at least one of a call from frequent location, a call to frequent location, a call type, a call from known entity, and a call to known entity. The location may be determined from a GPS sensor of the UE and known entity may be determined from the phonebook stored in the UE.

In a non-limiting example, the criteria may also include previous history of long duration call. However, the one or more criteria is not limited to above example and any other criteria which indicates the familiarity between caller is well within the scope of the present disclosure.

At step 503, the method 500 discloses capturing a plurality of parameters associated with the MO call or the MT call and the UE, if the MO call or the MT call satisfies the one or more criteria. The plurality of parameters associated with the MO call or the MT call may comprise at least one of audio codec, video codec, bit-rate, variation in Received Signal Strength Indicator (RSSI) values, and Evolved Packet System fallback condition. The plurality of parameters associated with the UE may comprise at least one of location, ambient temperature, mobility type, and battery level. These call parameters may be fetched from the network and UE parameters may be fetched directly from different sensor/modules of the UE, as discussed in above aspects. However, the plurality of parameters associated with the call and the plurality of parameters associated with the UE is not limited to above example, and any other parameter known to a person skilled in the art is well within the scope of present disclosure.

At step 505, the method 500 discloses correlating the plurality of parameters with historical call data to identify one or more patterns influencing the call quality.

At step 507, the method 500 discloses analyzing, using hybrid ML model, the correlations identified and predict call quality issues for the MO call or the MT call.

The hybrid ML model may be trained for predicting call quality issues. For training the hybrid ML model, the method 500 may comprise receiving historical call data of the UE. The historical call data comprises call parameters associated with a plurality of calls and corresponding contribution of the call parameters to influence the call quality during the plurality of calls. The method 500 may then comprise training the hybrid ML model with a plurality of patterns present in the historical call data. Each pattern may include a call parameter and corresponding contribution of the call parameter.

Further, the method 500 may comprise receiving a plurality of call quality issues experienced by users during the call and one or more respective issue resolution recommendation and training the hybrid ML model with the plurality of call quality issues experienced by the users during the call and the one or more respective issue resolution recommendation for real time UE resource adjustment.

At step 509, the method 500 discloses adjusting UE resources based on the predicted call quality issues and real time context data. The real time context data comprises at least one of ambient noise experienced during the MO call or the MT call, call mutes experienced during the MO call or the MT call, and real time voice metrics.

For the adjustment of the UE resources, the method 500 may comprise providing one or more of pre-allocation media protocol selection, adaptive bit-rate, network configuration optimization, application bandwidth prioritization, and recommendations for a user of the UE. However, the adjustment of UE resources is not limited to above example and any other UE resource adjustment that may improve the call quality for an identified/predicted call issue is well within the scope of present disclosure.

To provide recommendation for the user of the UE, the method 500 may comprise providing at least one of position change recommendation, reducing screen resolution recommendation during a video call, switching audio call to video call recommendation, and switching video call to audio call recommendation. However, the recommendation for the user is not limited to above example and any other recommendation for the user/user equipment is well within the scope of present disclosure.

Thus, if UE knows that user call to a known user from a specific location and had experienced call/voice quality/drop issues, the UE may pre-allocate more resource for call originating from that location. The UE can also suggest user during the call to move to a specific location or spot with the space if call quality starts to trouble the user during the conversation, thereby improving the overall call quality and improving user experience during the call.

The sequence of operations of the method 500 need not be necessarily executed in the same order as they are presented. Further, one or more operations may be grouped together and performed in form of a single step, or one operation may have several sub-steps that may be performed in parallel or in sequential manner.

The disclosed method with reference to FIG. 5, or one or more operations of the apparatus 400 explained with reference to FIG. 4 and may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the various embodiments described herein. The term “computer-readable medium” may be understood to include tangible items and exclude carrier waves and transient signals, e.g., be non-transitory. Examples include Random Access Memory (RAM), Read-Only Memory (ROM), volatile memory, non-volatile memory, hard drives, CD (Compact Disc) ROMs, DVDs, flash drives, disks, and any other known physical storage media.

It will be understood by those within the art that, in general, terms used herein, and are generally intended as “open” terms (e.g., the term “including” may be interpreted as “including but not limited to,” the term “having” may be interpreted as “having at least,” the term “includes” may be interpreted as “includes but is not limited to,” etc.). For example, as an aid to understanding, the detail description may contain usage of the introductory phrases “at least one” and “one or more” to introduce recitations. However, the use of such phrases may not be construed to imply that the introduction of a recitation by the indefinite articles “a” or “an” limits any particular part of description containing such introduced recitation to disclosure containing only one such recitation, even when the introductory phrases “one or more” or “at least one” and indefinite articles such as “a” or “an” (e.g., “a” and/or “an” may typically be interpreted as “at least one” or “one or more”) are included in the recitations; the same holds true for the use of definite articles used to introduce such recitations. In addition, even if a specific part of the introduced description recitation is explicitly recited, those skilled in the art will recognize that such recitation may typically be interpreted as at least the recited number (e.g., the bare recitation of “two recitations,” without other modifiers, typically refers to at least two recitations or two or more recitations).

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the disclosure, including the appended claims and their equivalents. It will also be understood that any of the embodiment(s) described herein may be used in conjunction with any other embodiment(s) described herein.

What is claimed is:

1. A method for optimizing call quality in a user equipment (UE), the method comprising:
identifying a mobile originated (MO) call or a mobile terminated (MT) call satisfying one or more criteria comprising a call from frequent location, a call to frequent location, a call type, a call from known entity, and a call to known entity;
capturing a plurality of parameters associated with the MO call or the MT call and the UE, based on the MO call or the MT call satisfying the one or more criteria;
correlating the plurality of parameters with historical call data to identify one or more patterns influencing the call quality;
analyzing, using a hybrid machine learning (ML) model, the one or more identified patterns and predicting call quality issues for the MO call or the MT call; and
adjusting UE resources based on the predicted call quality issues and real time context data.

2. The method as claimed in claim 1, wherein the plurality of parameters associated with the MO call or the MT call comprise at least one of: audio codec, video codec, bit-rate, variation in Received Signal Strength Indicator (RSSI) values, and Evolved Packet System fallback condition, and wherein the plurality of parameters associated with the UE comprise at least one of: location, ambient temperature, mobility type, and battery level.

3. The method as claimed in claim 1, wherein adjusting the UE resources comprises:
providing one or more of pre-allocation media protocol selection, adaptive bit-rate, network configuration optimization, application bandwidth prioritization, and recommendations for a user of the UE.

4. The method as claimed in claim 3, wherein providing the recommendation for the user of the UE comprises at least one of: position change recommendation, reducing screen resolution recommendation during a video call, switching audio call to video call recommendation, and switching video call to audio call recommendation.

5. The method as claimed in claim 1, further comprising:
receiving historical call data of the UE, wherein the historical call data comprises call parameters associated with a plurality of calls and corresponding contribution of the call parameters to influence the call quality during the plurality of calls; and
training the hybrid ML model with a plurality of patterns present in the historical call data, wherein each pattern includes a call parameter and corresponding contribution of the call parameter.

6. The method as claimed in claim 1, wherein the real time context data comprises at least one of: ambient noise present during the MO call or the MT call, call mutes experienced during the MO call or the MT call, and real time voice metrics.

7. The method as claimed in claim 1, further comprising:
receiving a plurality of call quality issues experienced by users during the call and one or more respective issue resolution recommendations; and
training the hybrid ML model with the plurality of call quality issues experienced by the users during the call and the one or more respective issue resolution recommendation for real time UE resource adjustment.

8. An apparatus configured to optimize and/or improve call quality in a user equipment (UE), the apparatus comprising:
a memory;
at least one processor, comprising processing circuitry, coupled to the memory and individually and/or collectively, configured to:
identify a mobile originated (MO) call or a mobile terminated (MT) call satisfying one or more criteria comprising at least one of a call from frequent location, a call to frequent location, a call type, a call from known entity, and a call to known entity;
capture a plurality of parameters associated with the MO call or the MT call and the UE, based on the MO call or the MT call satisfying the one or more criteria;
correlate the plurality of parameters with historical call data to identify one or more patterns influencing the call quality;
analyze, using a hybrid machine learning (ML) model, the correlations identified and predict call quality issues for the MO call or the MT call; and
adjust UE resources based on the predicted call quality issues and real time context data.

9. The apparatus as claimed in claim 8, wherein the plurality of parameters associated with the MO call or the MT call comprise at least one of: audio codec, video codec, bit-rate, variation in Received Signal Strength Indicator (RSSI) values, and Evolved Packet System fallback condition, and wherein the plurality of parameters associated with the UE comprise at least one of: location, ambient temperature, mobility type, and battery level.

10. The apparatus as claimed in claim 8, wherein to adjust the UE resources, at least one processor, individually and/or collectively, is configured to:
provide one or more of pre-allocation media protocol selection, adaptive bit-rate, network configuration optimization, application bandwidth prioritization, and recommendations for a user of the UE.

11. The apparatus as claimed in claim 10, wherein to provide recommendation for the user of the UE, at least one processor, individually and/or collectively, is configured to:
provide at least one of position change recommendation, reducing screen resolution recommendation during a video call, switching audio call to video call recommendation, and switching video call to audio call recommendation.

12. The apparatus as claimed in claim 8, wherein at least one processor, individually and/or collectively, is configured to:
receive historical call data of the UE, wherein the historical call data comprises call parameters associated with a plurality of calls and corresponding contribution of the call parameters to influence the call quality during the plurality of calls; and
train the hybrid ML model with a plurality of patterns present in the historical call data, wherein each pattern includes a call parameter and corresponding contribution of the call parameter.

13. The apparatus as claimed in claim 8, wherein the real time context data comprises at least one of: ambient noise experienced during the MO call or the MT call, call mutes experienced during the MO call or the MT call, and real time voice metrics.

14. The apparatus as claimed in claim 8, wherein at least one processor, individually and/or collectively, is configured to:
receive a plurality of call quality issues experienced by users during the call and one or more respective issue resolution recommendation; and
train the hybrid ML model with the plurality of call quality issues experienced by the users during the call and the one or more respective issue resolution recommendation for real time UE resource adjustment.
